(19) United States
(12) Patent Application Publication
(10) Pub. No.: US 2019/0337088 A1
(43) Pub. Date: Nov. 7, 2019

(54) WELDING METHOD AND PART MADE BY THE WELDING METHOD

(71) Applicant: GM GLOBAL TECHNOLOGY OPERATIONS LLC, DETROIT, MI (US)

(72) Inventors: Huaxin Li, Rochester Hills, MI (US); Daniel J. Wilson, Linden, MI (US)

(21) Appl. No.: 15/971,031

(22) Filed: May 4, 2018

(51) Int. Cl. B23K 20/12

(52) U.S. Cl. CPC B23K 20/1275; B23K 2201/006; B23K 20/126; B23K 20/125

(57) ABSTRACT

A method for welding a first component to a second component. The method includes providing a first component including a first alloy, providing a second component including a second alloy, heating the first component, and solid state welding the second component to the first component.

### FIELD

The present disclosure relates to a welding method and part made by the welding method.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Automotive manufacturers are concerned with employing advanced efficient fundamentals to create vehicles employing leading-edge technologies and to apply those technologies in a cost-effective manner. A mixed-material strategy attacks those challenges at the most fundamental levels, and provides multiple improvements, such as, for example, reduced vehicle weight, reduced vehicle drag, engine downsizing, transmission and engine efficiency.

A mixed-material strategy which pursues making vehicles more lightweight and stronger than ever has brought great benefits and advantages. Reducing mass by about ten percent improves fuel efficiency by about five percent. In addition to saving customers money and reducing overall emissions, vehicles employing more efficient designs and lighter-weight materials helps to eliminate billions of dollars in material costs. A mixed-materials strategy further enables a vehicle manufacturer to incorporate the most appropriate materials for each component, or each portion of a component, of the vehicle which then maximizes the performance and minimizes the weight of vehicles.

In a typical motor vehicle, certain components are welded together. Some welds involve components made of different alloys. For example, a lighter alloy such as aluminum or magnesium may be joined with a heavier alloy such as steel. However, because of the differences in physical and metallurgical properties between these alloys, the joint strength may not be strong enough for certain applications. In particular, it has been challenging to implement this strategy for components of a vehicle propulsion system, such as, for example, components in an engine or transmission, which may be subject to stricter property requirements than that for other components in a vehicle.

### SUMMARY

In an exemplary aspect, a method for welding a first component to a second component. The method includes providing a first component including a first alloy, providing a second component including a second alloy, heating the first component, and solid state welding the second component to the first component.

In this manner, by pre-heating the first component, the bond between the first component and a second component by a solid-state welding process such as, for example, a friction welding process provides a substantially improved bond between the first and second components. In turn, this enables a further extension of a mixed materials strategy which further enhances reliability, durability, performance, efficiency, weight and cost reduction to additional vehicle components such as that used in, for example, vehicle propulsion systems.

In another exemplary aspect, the first alloy has a higher melting point temperature than the second alloy.

In another exemplary aspect, heating the first component includes inductively heating the first component.

In another exemplary aspect, heating the first component includes locally heating a surface of the first component and solid state welding the second component to the first component includes solid state welding the second component to the heated surface of the first component.

In another exemplary aspect, heating the first component includes one of heating the first component in a furnace, heating the first component in an oven, laser beam heating the first component, and flame heating the first component.

In another exemplary aspect, heating the first component includes heating the first component to a temperature up to a melting point temperature of the first alloy.

In another exemplary aspect, heating of the first component includes reducing the hardness of the first component more than about 100 HV.

In another exemplary aspect, heating of the first component includes reducing the hardness of the first component more than about 200 HV.

In another exemplary aspect, the first alloy is one of a steel alloy, a copper alloy, and a nickel base alloy.

In another exemplary aspect, the second alloy is one of a magnesium alloy, a copper alloy, and an aluminum alloy.

In another exemplary aspect, the method makes a vehicle propulsion system component.

In another exemplary aspect, the vehicle propulsion system component is one of an engine component, an electric motor component, an electric storage component, and a transmission component.

In another exemplary aspect, a heat effected zone of the first component extends to a depth of more than about 0.5 millimeters from an interface between the first component and the second component.

In another exemplary aspect, a heat effected zone of the first component extends to a depth of more than about 1.0 millimeters from an interface between the first component and the second component.

In another exemplary aspect, a heat effected zone of the first component extends to a depth of more than 2.0 millimeters from an interface between the first component and the second component.

In another exemplary aspect, a hardness of a heat effected zone of the first component is reduced by more than about 100 HV from a non-heat effected zone of the first component.

In another exemplary aspect, a hardness of a heat effected zone of the first component is reduced by more than about 200 HV from a non-heat effected zone of the first component.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1A is a schematic diagram of a rotational friction welding system;

FIG. 1B is side view of two exemplary components welded together with the system shown in FIG. 1A;

FIG. 2 illustrates an exemplary interface between a steel component and an aluminum component created with a friction welding system;

FIG. 3 illustrates an exemplary induction heating coil applying heat to a surface of a steel component prior to friction welding; and

FIG. 4 is a graph 400 illustrating hardness patterns in components joined by friction welding.

In the drawings, reference numbers may be reused to identify similar and/or identical elements.

### DETAILED DESCRIPTION

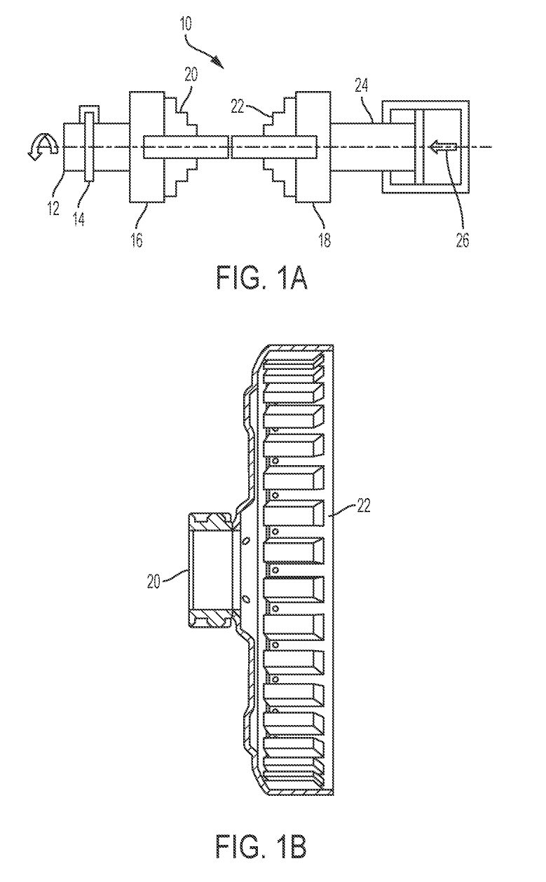

Referring now to the drawings, a rotational friction weld system is shown in FIG. 1A at 10. The system 10 includes a motor 12 that rotates a rotating chuck 16. A brake 14 is employed to control the rotational speed of the rotating chuck 16. The system 10 further includes a non-rotating chuck 18 coupled to a hydraulic cylinder 24.

When the system 10 is in use, the rotating chuck 16 holds a first work piece or component 20 and the non-rotating chuck 18 holds a second work piece or component 22. The first and second work pieces are made of dissimilar materials. For example, in certain arrangements the first work piece 20 may be a steel gear and the second work piece 22 may be an aluminum clutch shell.

The motor 12 spins the rotating chuck 16 and hence the first work piece 20 at a high rate of rotation. When the first work piece 20 is spinning at the proper speed, the hydraulic cylinder 24 moves the non-rotating chuck 18 and hence the second work piece 22 towards the first work piece 20 in the direction of the arrow 26. Accordingly, the two work pieces 20 and 22 are forced together under pressure to form a frictional weld that joins the two work pieces together as shown in FIG. 1B. The spinning is stopped to allow the weld to set. In conventional friction welding systems, the physical and metallurgical property differences between the different alloys may result in poor bonding because of the poor distribution of heat. Poor distribution of heat may result in a heat imbalance across the joint face which may cause, for example, a lower melting point temperature alloy deforming excessively while a higher melting point temperature alloy may not be heated sufficiently to provide an adequate bond at the joint. Pre-heating of the workpiece having a higher melting point temperature prior to friction welding, in accordance with the present disclosure, improves the quality of the bond at the joint.

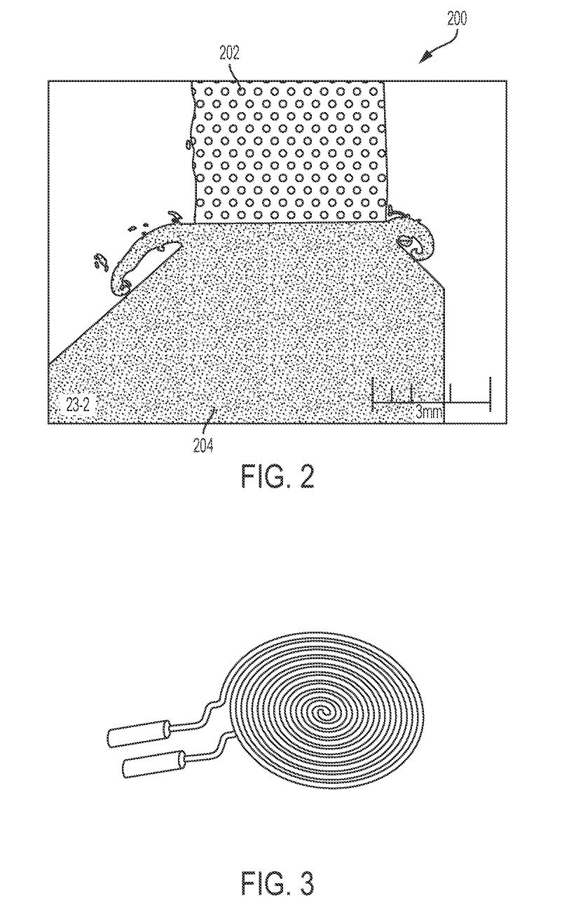

FIG. 2 illustrates an interface 200 between a steel component 202 and an aluminum component 204 formed by a friction welding process. As can be seen in FIG. 2, the material at the interface of the aluminum component 204 may be pushed aside or outwardly while the material in the steel component 202 is not deformed. This is due to the difference in characteristics between the steel alloy and the aluminum alloy.

Further, while the present detailed description describes and illustrates a steel gear and aluminum clutch shell, it is to be understood that exemplary embodiments of the present disclosure may be applicable to combining two dissimilar alloys to form a single component. Exemplary embodiments of the present disclosure may be useful in providing components for an automobile such as in a vehicle propulsion system.

In an exemplary aspect, in order to improve the temperature distribution across the components being welded together, the component that is made of an alloy having a higher melt temperature may be heated prior to friction welding the two components together. In the absence of pre-heating of the higher melting point material, not enough heat may be generated to ensure a strong bond between the components. For example, the melting point of a component made of a steel alloy may be about 1450 degrees Celsius and the melting point of a component made of an aluminum alloy may be about 600 degrees Celsius. The heat that is generated during the friction welding is distributed between both components and, since the aluminum has a lower melting point, the aluminum is affected more by the heat than the steel and, as a result, as shown in FIG. 2, the aluminum deforms more than the steel and the bond is not a strong as it could be.

In an exemplary aspect of the present disclosure, the steel component is heated prior to the friction welding process. In this manner, the temperature of the steel is increased, which reduces the necessity of the friction welding process to provide heat to the steel, and which further improves the ability of the steel to bond to the aluminum.

FIG. 3 illustrates an exemplary embodiment in which an induction heating coil 300 is positioned adjacent to a surface of a steel component 302 to be bonded to an aluminum component (not shown). The induction heating coil 300 may be energized from a suitable source of high frequency alternating electric current (not shown) which causes a high density alternating current to be induced to flow in the steel component 302 which, in turn, generates heat within the steel component 302. In this manner, the amount of heat which is required to be introduced into the steel component 302 by a subsequent friction welding process to ensure an adequate bond is much less.

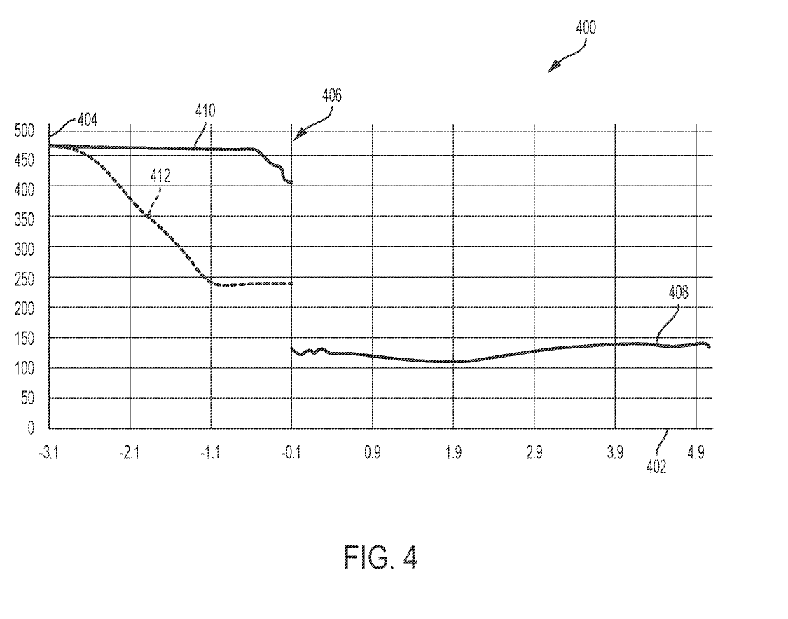

FIG. 4 is an exemplary graph 400 illustrating the distribution of hardness (in Vickers Hardness) across varying distances from a joint between a steel component and an aluminum component. The horizontal axis 402 represents the distance (in millimeters) from the joint 406 between the components and the vertical axis 404 corresponds to the hardness of the material at each distance. In the exemplary embodiments represented in the graph 400, the hardness for an aluminum component is represented by line 408, the hardness of a steel component which has undergone conventional friction welding to the aluminum component is represented by line 410, and the hardness of a steel component which has undergone pre-heating followed by friction welding to the aluminum component in accordance with the present disclosure is represented by line 412.

As is clearly illustrated, in the absence of pre-heating, the steel component hardness 410 is hardly affected at all and only drops a small amount and only near the interface 406 with the aluminum component. In stark contrast, the hardness 412 of the steel component drops significantly and the depth of the hardness effect is increased in comparison to the hardness 410 of the non-pre-heated steel component. In this particular instance, the steel component was pre-heated to about 650 degrees Celsius prior to friction welding to the aluminum component. Pre-heating the steel component prior to friction welding reduces the amount of heat that is required to be generated by friction to heat the steel and produce a more uniform distribution of heat to the entire joint fay-face. As a result, the amount of time required by the friction welding process to provide a bond is significantly reduced while simultaneously achieving a stronger bond. Further, the difference in hardness between the steel component and the aluminum component is significantly reduced which, in turn, also improves the bond between these components from friction welding.

The pre-heating of the steel component in accordance with the present disclosure also provides a greater reduction in hardness than which has been previously achievable. In this particular example, a reduction in Vickers Hardness of more than 200 HV is achieved. This stands in stark contrast to the reduction in hardness of only about 70 HV at the interface as a result only of the heat introduced by a conventional friction welding process.

Further, the pre-heating of the steel component may be easily detected by comparing the larger and deeper hardness pattern 412 of the steel component in comparison to that the hardness pattern 410 in a steel component which has not been pre-heated in accordance with the present disclosure. In other words, the depth of the heat effected zone produced by the conventional friction welding (without pre-heating) in the steel component is much less than that of the total/effective case hardness or depth of the heat effected zone of the steel component which has undergone pre-heating prior to friction welding in accordance with the present disclosure. The depth of the heat effected zone of the hardness pattern 410 is only about 0.5 millimeters while, in stark contrast, the depth of the heat effected zone of the hardness pattern 412 extends deeper than 0.5 millimeters, or in this instance, about two millimeters deep into the component. In some exemplary embodiments, the heat effected zone may extend to a depth of about three millimeters or more. This is a measurable and distinct improvement.

While the present disclosure describes pre-heating of a component using an induction heating coil, any type of heating may be used and still be considered to form a portion of the present disclosure, without limitation. For example, alternatives to induction heating may include, for example, laser beam heating, furnace heating, flame heating and/or the like.

In a preferred aspect, the heating may be localized to the surface of the component to be joined to another component. In this manner, potential adverse effects of that heating on the material properties of the remainder of that component may be minimized and/or entirely avoided. Further, in a preferred aspect, the heating may be controlled such that the temperature of the component is maintained below the melting point temperature of that component.

While the exemplary disclosure describes joining a steel component to an aluminum component, the present disclosure is not limited to joining those alloys. Rather, the method of the present disclosure may be used to join any two metallic alloys having different melting temperatures. The alloy having a higher melting temperature may be pre-heated prior to friction welding. Exemplary alloys which may be joined include, for example, steel or copper or nickel base alloy to aluminum or magnesium, steel to copper, any combination of metals, and the like, without limitation.

Further, while the present detailed description describes and illustrates a steel gear and aluminum clutch shell, it is to be understood that exemplary embodiments of the present disclosure may be applicable to combining two dissimilar alloys to form a single component. Exemplary embodiments of the present disclosure may be useful in providing components for an automobile such as in a vehicle propulsion system.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for welding a first component to a second component, the method comprising:
providing a first component comprising a first alloy;
providing a second component comprising a second alloy;
heating the first component; and
solid state welding the second component to the first component.

2. The method of claim 1, wherein the first alloy has a higher melting point temperature than the second alloy.

3. The method of claim 1, wherein heating the first component comprises inductively heating the first component.

4. The method of claim 1, wherein heating the first component comprises locally heating a surface of the first component and wherein solid state welding the second component to the first component comprises solid state welding the second component to the heated surface of the first component.

5. The method of claim 1, wherein heating the first component comprises one of heating the first component in a furnace, heating the first component in an oven, laser beam heating the first component, and flame heating the first component.

6. The method of claim 1, wherein heating the first component comprises heating the first component to a temperature up to a melting point temperature of the first alloy.

7. The method of claim 1, wherein the heating of the first component comprises reducing the hardness of the first component more than about 100 HV.

8. The method of claim 1, wherein the heating of the first component comprises reducing the hardness of the first component more than about 200 HV.

9. The method of claim 1, wherein the first alloy comprises one of a steel alloy, a copper alloy, and a nickel base alloy.

10. The method of claim 1, wherein the second alloy comprises one of a magnesium alloy, a copper alloy, and an aluminum alloy.

11. A vehicle propulsion system component made by the method of claim 1.

12. The vehicle propulsion system component of claim 11, wherein the vehicle propulsion system component comprises one of an engine component, an electric motor component, an electric storage component, and a transmission component.

13. The vehicle propulsion system component of claim 11, wherein a heat effected zone of the first component extends to a depth of more than about 0.5 millimeters from an interface between the first component and the second component.

14. The vehicle propulsion system component of claim 11, wherein a heat effected zone of the first component extends to a depth of more than about 1.0 millimeters from an interface between the first component and the second component.

15. The vehicle propulsion system component of claim 11, wherein a heat effected zone of the first component extends to a depth of more than 2.0 millimeters from an interface between the first component and the second component.

16. The vehicle propulsion system component of claim 11, wherein a hardness of a heat effected zone of the first component is reduced by more than about 100 HV from a non-heat effected zone of the first component.

17. The vehicle propulsion system component of claim 11, wherein a hardness of a heat effected zone of the first component is reduced by more than about 200 HV from a non-heat effected zone of the first component.

18. The vehicle propulsion system component of claim 11, wherein the first alloy has a higher melting point temperature than the second alloy.

19. The vehicle propulsion system component of claim 11, wherein the first alloy comprises one of a steel alloy, a copper alloy, and a nickel base alloy.

20. The vehicle propulsion system component of claim 11, wherein the second alloy comprises one of a magnesium alloy, a copper alloy, and an aluminum alloy.
